(19) United States
(12) Patent Application Publication
(10) Pub. No.: US 2010/0064440 A1
(43) Pub. Date: Mar. 18, 2010

(54) DEVICE FOR SUPPORTING A PATIENT

(76) Inventors: Patrick Armstrong Finlay, Beaconsfield Bucks (GB); Edmund Jan Bonikowski, Isleworth (GB); Scot Glickman, Kingswood (GB)

Correspondence Address: SHOOK, HARDY & BACON LLP;INTELLECTUAL PROPERTY DEPARTMENT, 2555 GRAND BLVD, KANSAS CITY, MO, 64108-2613, US

(21) Appl. No.: 12/162,272

(22) PCT Filed: Jan. 23, 2007
(86) PCT No.: PCT/GB2007/000216

§ 371 Date: Dec. 2, 2009

(30) Foreign Application Priority Data
Jan. 25, 2006 (GB) 0601512.7

(51) Int. Cl. A61G 5/00; A47C 13/00; A61G 7/00; A61G 7/015; A61G 7/057

(52) U.S. Cl. 5/613; 297/118

(57) ABSTRACT

A device for supporting a patient, the device comprising first and second support members adapted to support respective first and second parts of a patient's body and being operable to move between a first configuration and a second configuration, wherein when a patient is supported by the device and the device is in the first configuration, the patient is in a first bodily position and is supported by the first support member, with little or none of the patient's weight being supported by the second support member, and when a patient is supported by the device and the device is in the second configuration, the patient is in a second bodily position and is supported by the second support member, with little or none of the patient's weight being supported by the first support member.

### DESCRIPTION OF INVENTION

This invention relates to a device for supporting a patient, and in particular concerns a powered device for supporting a patient in such a way as to minimise the occurrence of pressure sores.

Pressure sores, also known as pressure ulcers, bedsores or decubitis ulcers, are a serious problem in hospital and residential nursing care homes. Pressure sores usually occur when a patient remains in the same position for a long period of time, and when a significant portion of the patient's weight is supported on the same part of the patient's body. Pressure sores occur when the pressure of surrounding stressed tissue causes blood flow to an area to be blocked. If soft tissue is deprived of oxygenated blood for more than a short time, sometimes as little as a few minutes, irreversible damage is caused and the tissue dies. These areas then become pressure sores, areas of necrotic tissue which are painful and require significant nursing in order to heal.

The pressure and time required to induce pressure sores depends on various factors associated with the patient and the environment. However, it is well known that if the pressure on a stressed area can be relieved every few minutes, blood flow is re-established and the tissues of the stressed area are reperfused with oxygenated blood, preventing the onset of pressure sores. The extent to which pressure must be relieved to allow reperfusion varies from patient to patient, with partial relief being adequate in some cases but not others. The only method of ensuring reperfusion is to remove all pressure from the stressed area.

Patients at risk of developing pressure sores are usually nursed in a lying position in order to spread their weight and reduce local concentrations of pressure. However, medically it is often preferable to nurse patients in a seated position, as this assists cardiovascular and respiratory function, postural muscle control and digestion. There is also the opportunity for increased social interaction when sitting up. Unfortunately, for at-risk patients maintaining a sitting posture for significant lengths of time is likely to produce pressure concentrations in the gluteal region, and this is therefore inadvisable for such patients.

Present techniques for prevention of pressure sores include compliant surfaces, gel supports, ripple mattresses and low loss air beds. None of these methods has been found to be entirely effective in preventing pressure sores, however. It is an object of the present invention to seek to provide an improved device for supporting a patient in such a way that the occurrence of pressure sores is discouraged.

Accordingly, one aspect of the present invention provides a device for supporting a patient, the device comprising first and second support members adapted to support respective first and second parts of a patient's body and being operable to move between a first configuration and a second configuration, wherein when a patient is supported by the device and the device is in the first configuration, the patient is in a first bodily position and is supported by the first support member, with little or none of the patient's weight being supported by the second support member, and when a patient is supported by the device and the device is in the second configuration, the patient is in a second bodily position and is supported by the second support member, with little or none of the patient's weight being supported by the first support member.

Advantageously, the device is operable to move repeatedly between the first and second configurations.

Preferably, the movements between the first and second configurations take place at regular intervals.

Conveniently, when a patient is supported by the device and the device is in the first configuration, the second support member is withdrawn from the patient's body so that a space exists between the second support member and the patient's body.

Advantageously, when a patient is supported by the device and the device is in the second configuration, the first support member is withdrawn from the patient's body so that a space exists between the first support member and the patient's body.

Preferably, the first bodily position is a sitting position.

Conveniently, the first part of the patient's body at least includes at least a part of the patient's gluteal region.

Advantageously, the second bodily position is a kneeling position.

Preferably, the second part of the patient's body at least includes at least a part of the patient's knee or shin.

Conveniently, the height of the first and second support members may be adjusted.

Advantageously, the device further includes a third support member for supporting a third region of the patient's body.

Preferably, the third support member comprises a foot support.

Conveniently, the first bodily position is a sitting position, the patient's knees being maintained at a first angle in the first bodily position, the second bodily position is a kneeling position, the patient's knees being maintained at approximately the first angle in the second bodily position, and during movement of the device from the first configuration to the second configuration, the patient's knees are placed at a second angle, the second angle being smaller than the first angle.

Advantageously, the first angle is approximately a right angle.

Preferably, the second angle is less than 45°.

Advantageously, the second angle is approximately 30°.

Preferably, the device further comprises an upper body restraint arrangement to assist in maintaining the upper body of the patient in position.

Conveniently, the upper body restraint arrangement comprises a belt or strap.

Advantageously, the device comprises a return mechanism to allow the device to move directly into a predetermined state.

Preferably, the predetermined state is the first or second configuration.

Another aspect of the present invention provides a device for supporting a patient, comprising: first and second support members for supporting respective first and second parts of a patient's body, the first and second support members being individually moveable and the device being moveable between a first configuration and a second configuration, wherein when a patient is supported by the device and the device is in the first configuration, the patient is at least partially supported by the first support member, with the second support member being removed from the patient's body so that a space exists between the second support member and the patient's body, and when a patient is supported by the device and the device is in the second configuration, the patient is at least partially supported by the second support member, with the first support member being removed from the patient's body so that a space exists between the first support member and the patient's body.

Conveniently, the first and second support members are each moveable between a first position and a second position.

Advantageously, the first and second support members are each moveable between a first height and a second height.

Preferably, both the first and second support members may be placed at the first height to form part of a substantially level surface.

Conveniently, at least one further support member is provided, arranged so that, when the device is in the first configuration, the patient is supported by at least the first support member and the further support member and, when the device is in the second configuration, the patient is supported by at least the first support member and the further support member.

Advantageously, the device is operable to move repeatedly between the first and second configurations.

Preferably, the movements between the first and second configurations take place at regular intervals.

Conveniently, the device further comprises a plurality of further individually moveable support members, moveable between any of a plurality of support configurations in each of which, when a patient is supported by the device, at least one of the support members is removed from the patient's body so that a space exists between the support member and the patient's body.

In order that the present invention may be more readily understood, embodiments thereof will now be described, by way of example, with reference to the accompanying drawings, in which:

FIGS. 1 to 3 are schematic representations of a patient support device embodying the present invention;

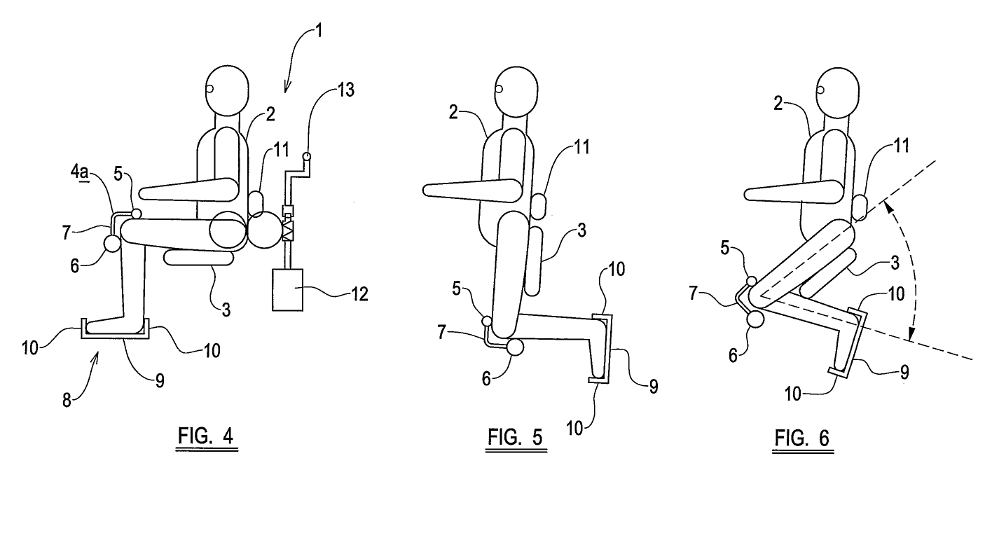

FIGS. 4 to 6 are schematic representations of an alternative patient support device embodying the present invention; and

FIG. 7 is a further patient support device embodying the present invention.

Referring firstly to FIGS. 1 and 4, a patient support device 1 embodying the present invention is shown in a sitting configuration, supporting a patient 2 in a sitting position. The patient support device 1 comprises a gluteal support 3, which is approximately rectangular, of suitable dimensions to support the gluteal region of the patient 2 and is preferably comfortably padded. In the sitting configuration of the patient support device 1, the gluteal support 3 is oriented horizontally.

In the embodiment shown in FIG. 1, the patient support device 1 further comprises a lower leg support 4, which comprises a padded member, preferably rectangular in shape, against which all or a part of the patients shins may rest. The padded member of the lower leg support 4 is preferably oriented substantially at right angles to the gluteal support 3.

FIGS. 4 to 6 show a patient support device having an alternative lower leg support 4a, which comprises first and second substantially parallel elongate padded bars 5, 6. The bars 5, 6 are connected together by an L-shaped connector 7, having two arms of approximately equal length joined at a right-angle. The alternative lower leg support 4a is placed so that, when the patient 2 sits on the gluteal support 3, the first bar 5 rests across the front of the lower thighs of the patient 2, close to the patellae of the patient 2, and the second bar 6 rests across the upper parts of the shins of the patient 2, again close to the patellae. It is envisaged that the distance between the gluteal support 3 and the lower leg support 4, 4a may be adjustable, to accommodate patients having different femur lengths.

The knee support may take different forms to that described above, to provide adequate support for the patient's lower leg. For instance, both the shins and knees of the patient 2 may be supported.

The patient support device 1 also comprises a foot support 8, in the form of a substantially square plate 9 on which the soles of the patient's feet may rest. Preferably raised lips 10 are provided at the front and back of the plate 9, adjacent the toes and heels of the patient's feet, to retain the patient's feet on the plate 9. Alternatively, or in addition, one or more straps (not shown) may be provided to keep the patient's feet in place. In the sitting configuration, the plate 9 of the foot support 8 is substantially horizontal. Therefore, in the sitting position, the femurs of the patient 2 are substantially horizontal, and the shins of the patient are substantially vertical, the legs of the patient 2 being bent through approximately 90° at the knee. The distance between the foot support 8 and the lower leg support 4, 4a may be variable, to accommodate patients having different shin lengths.

It is envisaged that, when the patient 2 is supported by the patient support device 1, the torso of the patient 2 will be substantially upright. A lumbar support 11 is provided, in the form of wide, padded bar against which the lower back of the patient 2 rests. A seat belt or strap (not shown) may also be provided to give additional support for patients with poor postural support or who may fall asleep. A conventional seat back and seat arms may also be provided, to give comfort and a feeling of additional security to the patient 2.

It is envisaged that the gluteal support 3, lower leg support 4, 4a and foot support 8 will all be supported on a central support pillar 12, and be provided on respective moveable arms. The arms are connected to a driving actuator 12 so that the gluteal support 3, lower leg support 4, 4a and foot support 8 may each be rotated around an axis which passes substantially through the hip joint of the patient 2, as will be described below.

FIGS. 2 and 5 show the patient support device 1 in a kneeling configuration. In this configuration, the gluteal support 3 is substantially horizontal, and is generally located beneath the lumbar support 11. The femurs of the patient 2 extend downwardly from the patient's upper body, which is in the same position as before. The lower leg support 4, 4a remains in the same position relative to the knee of the patient 2, which is again bent through approximately 90° . It will be understood that much of the patient's weight will rest on the padded member of the lower leg support 4 or, if the alternative lower leg support 4a is used, on the second bar 6, which contacts the upper parts of the shins of the patient 2. The foot support 8 is approximately vertical, with the soles of the patient's feet still being in contact therewith. It will be understood that, if the gluteal support 3, lower leg support 4, 4a and foot support 8 are each rotated around an axis passing substantially through the hip joint of the patient 2, these components will arrive in these positions.

The movement of the gluteal support 3 however, is preferably not solely rotational. The changing shape of the gluteal muscles as the patient's posture alters requires an additional translation of the gluteal support 3 as it rotates, to prevent shear on the patient 2. This can be achieved by allowing the seat to slide passively forwards and backwards by a small amount (preferably by a few cm) in a guide or bearing arrangement incorporating a spring return system, or being actively powered. In the latter case, it is advantageous to have an adjustment to allow the amount of translation to be varied to suit the individual patient 2. This may be achieved, for example, by using a crank arm with an adjustable stroke, but it will be appreciated that there are many other possible mechanisms that could be used.

When in the kneeling position, the patient 2 is preferably prevented from falling forwards by a chest support (not shown) comprising a padded bar or cushion supported in front of the patient's chest. In preferred embodiments of the invention, provision is made for the gluteal support 3 to be removed completely to allow access to the patient, for example for dressing purposes. The gluteal support 3 may, for example, be rotated out of position around a hinge pin provided on a distal end of the arm that supports the gluteal support 3. An interlock or other mechanism requires the gluteal support 3 to be replaced before any further motion of the components of the patient support device 1 takes place.

The patient's leg may be maintained in the same position (i.e. bent through approximately 90°) throughout the movement from the sitting configuration to the kneeling configuration. This does have the benefit of simplicity with regard to the movement mechanism, but does require the patient to be supported a relatively large distance above the ground, to ensure that the patient's feet do not scrape on the floor as the patient support device 1 moves from the sitting configuration to the kneeling configuration. In many situations this may be appropriate, since the patient can then comfortably hold a conversation with a standing person. Provision should, however, be made for lowering the patient support device 1 to bed height at the start and end of a period of use, to allow easy transfer from the bed to the patient support device 1. Preferably, an interlock or other device prevents the patient support device 1 from moving between the sitting configuration and the kneeling configuration unless the patient support device 1 has been raised to an appropriate height.

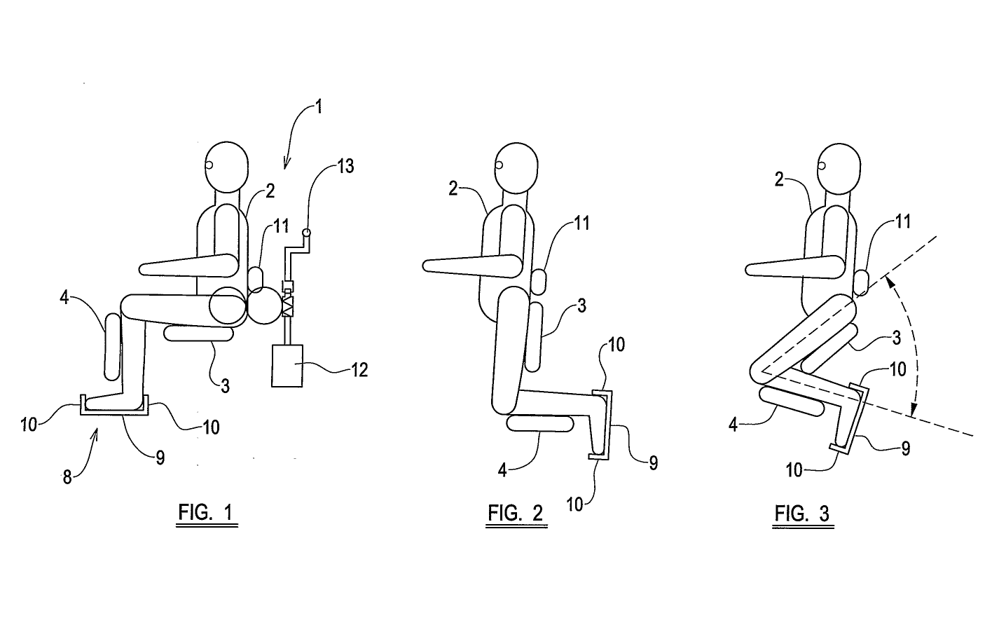

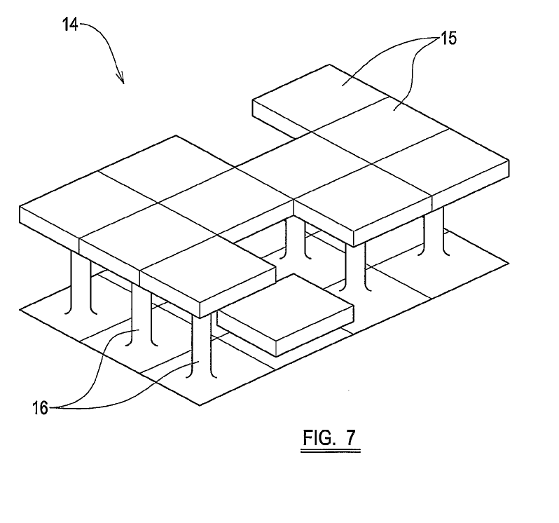

As an alternative, however, the angle of bend of the patient's knees may be increased during the transition from the sitting configuration to the kneeling configuration, particularly during the part of the motion when the patient's feet are at the lowest point of their trajectory. An appropriate way to achieve this would be for the foot support 8 to move more swiftly to its final position during the transition from the sitting configuration to the kneeling configuration, and more slowly during the return transition from the kneeling configuration to the sitting configuration, although a skilled person will realise that there are many other ways in which this may be achieved. Preferably, the greatest angle of bend of the patient's knee is about 120° (i.e. there is an angle of about 60° between the patient's femur and the patient's shin). This allows the patient support device 1 to be located closer to the ground, since the patient's feet are effectively “tucked up” during the lowest point of their trajectory, as shown in FIGS. 3 and 6.

Preferably, the patient support device 1 is configured to move between the sitting configuration and the kneeling configuration at regular intervals. For instance, a motion cycle of the patient support device 1 may take about 15 minutes, 3 minutes of which are taken up by the transition from the sitting configuration to the kneeling configuration and back again, and around 10 minutes are then spent in the sitting configuration before the next cycle begins. Alternatively, the cycle may incorporate a 2-minute pause in the kneeling position, and a 10-minute pause in the sitting position, with the remainder of the 15-minute cycle being taken up with movement between these positions. Of course, many other cycles are possible and will be of benefit to the patient. It is of importance, however, that the region of the patient on which the patient's weight is supported is changed regularly.

In preferred embodiments of the invention, the movement cycle is powered using a single actuator 12 which tilts the gluteal support 3, the lower leg support 4 and the foot support 8. Vertical motion of the patient support device 1 may also be powered by this actuator 12, or alternatively this motion may be powered by a second actuator. The actuators may be of any appropriate type, for instance electric motors, or hydraulic or pneumatic cylinders. Advantageously a battery backup or manual mechanism (for instance a crank or over-ride handle 13) may be provided to return the patient to the sitting position in the event of a mechanical or power failure. A quick return function can be provided to return the patient to the sitting position and patient support device 1 to transfer height, for use when needed urgently, for instance in the event of a fire alarm being activated.

For many patients, the ability to operate the controls of the patient support device 1 will be preferable, although the controls may be positioned for operation by a carer. In preferred embodiments, the patient support device 1 is configured to provide an alarm or warning when the patient support device 1 has been in the same position for too long. Optionally, the patient support device 1, or a portable device carried by a patient, may be provided with a memory in which settings for one or more individual patients may be stored. These settings may then be recalled when a patient uses the patient support device 1. It will be appreciated that this may be achieved by using a swipe-card or keypad system.

An important feature of embodiments of the invention relates to the complete removal of a support from the patient's body. As discussed above, the only way to be sure that blood is reperfused to a stressed area is for all contact between that area and a supporting device to be removed. In conventional support devices such as ripple mattresses, supporting regions of the device are manoeuvred so that very little of the patient's weight is borne through the supporting region, or so that very little contact force remains. However, typically some contact force does remain, thus increasing the chance of pressure sores forming. In embodiments of the invention, at least one supporting region of a patient support device is completely removed from contact with the patient, so that a space exists between the patient's body and the support region.

In the case of the patient support device 1 described above, the patient support device 1 may be provided with a gluteal support 3 that, whilst in the kneeling configuration, moves away from the patient's body (in a direction substantially perpendicular with the plane of the gluteal support 3) so that a space is left between the patient's body and the gluteal support 3. In addition, or alternatively, whilst in the sitting configuration the support 4, 4a may be operable to move away from the patient's body (in a direction substantially parallel with the patient's femur) so that a space is left between the patient's body and the lower leg support 4, 4a.

Alternatively (as shown in FIG. 7), a device 14 forming a substantially flat surface may be provided, having an array of individual padded support elements 15, provided on respective actuators 16 (e.g. hydraulic actuators) whose heights may be controlled independently. Preferably, each of the support elements 15 is substantially square or rectangular in shape, or otherwise tessellate so that, when the support elements 15 are arranged to be at the same height, the support elements 15 are contiguous and provide a substantially flat surface of a suitable size on which a patient may lie. In a default position, all of the support elements 15 may be placed in a raised position. One or more of the support elements 15 may, however, be moved by its actuator 16 to a lower height, there being a sufficient difference in height between the one or more support elements 15 and the remaining support elements 15 that the one or more support elements 15 are completely removed from contact with the body of the patient (assuming that the patient is lying flat on the surface provided by the remaining support elements 15), such that a space exists between the body of the patient and each of the one or more support elements 15.

In preferred embodiments of the invention, the support elements follow a motion cycle so that, over a time period, each support element 15 is withdrawn in turn from the patient's body so that each area of the patient's body has a respite from pressure. Optionally, more than one of the support elements 15 may be withdrawn at any one time, in such a way that the patient's body is still adequately supported by the remaining support elements (as shown in FIG. 7).

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1-28. (canceled)

29. A device for supporting a patient, the device comprising first and second support members adapted to support respective first and second parts of a patient's body and being operable to move between a first configuration and a second configuration, wherein
when a patient is supported by the device and the device is in the first configuration, the patient is in a first bodily position and is supported by the first support member, with little or none of the patient's weight being supported by the second support member, and
when a patient is supported by the device and the device is in the second configuration, the patient is in a second bodily position and is supported by the second support member, with little or none of the patient's weight being supported by the first support member.

30. A device according to claim 29, operable to move repeatedly between the first and second configurations.

31. A device according to claim 30, wherein the movements between the first and second configurations take place at regular intervals.

32. A device according to claim 29, wherein, when a patient is supported by the device and the device is in the first configuration, the second support member is withdrawn from the patient's body so that a space exists between the second support member and the patient's body.

33. A device according to claim 29 wherein, when a patient is supported by the device and the device is in the second configuration, and the first support member is withdrawn from the patient's body so that a space exists between the first support member and the patient's body.

34. A device according to claim 29, wherein the first bodily position is a sitting position.

35. A device according to claim 29, wherein the second bodily position is a kneeling position.

36. A device according to claim 29, wherein:
the first bodily position is a sitting position, the patient's knees being maintained at a first angle in the first bodily position;
the second bodily position is a kneeling position, the patient's knees being maintained at a approximately the first angle in the second bodily position; and
during movement of the device from the first configuration to the second configuration, the patient's knees are placed at a second angle, the second angle being smaller than the first angle.

37. A device according to claim 36, wherein the first angle is approximately a right angle.

38. A device according to claim 36, wherein the second angle is less than 75°.

39. A device according to claim 29, further comprising an upper body restraint arrangement to assist in maintaining the upper body of the patient in position.

40. A device according to claim 29, comprising a return mechanism to allow the device to move directly into a predetermined state.

41. A device according to claim 40, wherein the predetermined state is the first or second configuration.

42. A device for supporting a patient, comprising:
first and second support members for supporting respective first and second parts of a patient's body, the first and second support members being individually moveable and the device being moveable between a first configuration and a second configuration, wherein
when a patient is supported by the device and the device is in the first configuration, the patient is at least partially supported by the first support member, with the second support member being removed from the patient's body so that a space exists between the second support member and the patient's body, and
when a patient is supported by the device and the device is in the second configuration, the patient is at least partially supported by the second support member, with the first support member being removed from the patient's body so that a space exists between the first support member and the patient's body.

43. A device according to claim 42, wherein the first and second support members are each moveable between a first position and a second position.

44. A device according to claim 42, wherein the first and second support members are each moveable between a first height and a second height.

45. A device according to claim 42, wherein at least one further support member is provided, arranged so that, when the device is in the first configuration, the patient is supported by at least the first support member and the further support member and, when the device is in the second configuration, the patient is supported by at least the first support member and the further support member.

46. A device according to claim 42, operable to move repeatedly between the first and second configurations.

47. A device according to claim 46, wherein the movements between the first and second configurations take place at regular intervals.

48. A device according to claim 42, further comprising a plurality of further individually moveable support members, moveable between any of a plurality of support configurations in each of which, when a patient is supported by the device, at least one of the support members is removed from the patient's body so that a space exists between the support member and the patient's body.
